(19) United States
(12) Patent Application Publication
(10) Pub. No.: US 2018/0157770 A1
(43) Pub. Date: Jun. 7, 2018

(54) GEOMETRIC PROXIMITY-BASED LOGGING FOR VEHICLE SIMULATION APPLICATION

(71) Applicant: TOYOTA JIDOSHA KABUSHIKI KAISHA, Toyota-shi (JP)

(72) Inventors: BaekGyu Kim, Mountain View, CA (US); Jonathan Shum, Mountain View, CA (US); Shinichi Shiraishi, Mountain View, CA (US); Yusuke Kashiba, Mountain View, CA (US)

(21) Appl. No.: 15/368,891

(22) Filed: Dec. 5, 2016

(51) Int. Cl. G06F 17/50

(52) U.S. Cl. CPC G06F 17/5009

(57) ABSTRACT

The disclosure includes embodiments for limiting the data logged for a simulation that is operable to test a performance of a virtual control system included in a virtual vehicle. A method includes executing the simulation, thereby causing a frame to be visually displayed on a display panel. The frame visually depicts the virtual vehicle moving in a virtual roadway environment having a dynamic object. The method includes assigning a monitored area around the virtual vehicle as it moves in the virtual roadway environment. The method includes monitoring the monitored area and determining that a critical period is occurring in the frame based on a presence of the dynamic object in the monitored area during the frame. The method includes storing critical period data. The critical period data is limited so that it consists of a description of one or more features which are present during the frame.

### BACKGROUND

The specification relates to improving the performance of a simulation application by providing geometric proximity-based logging of data describing an operation of a virtual control system.

Vehicle control systems are becoming increasingly popular. One example of a vehicle control system is an Advanced Driver Assistance System (“ADAS system” if singular, “ADAS systems” if plural, and the term “ADAS features” refers to examples of functionality provided by one or more ADAS systems).

An ADAS system functions properly when it operates in accordance with its specification (as defined by automobile design engineers who designed the ADAS system) as well as industry standards (as defined by standards creation bodies) and government standards (as defined by governmental administrative agencies or elected law makers).

Proper functioning of ADAS systems depends on the rigorous testing of the operation of the ADAS system to ensure that the operate in accordance with their specification and existing industry and governmental standards. This testing must occur before new or updated ADAS systems are ever included in a vehicle which is sold to the public.

The existing solution for testing the operation of a new or updated ADAS system is to include a prototype version of the ADAS system in a test vehicle which is then operated on a closed track for thousands or millions of miles. Software and sensors are installed in the test vehicle to measure the operation of every measurable aspect of the test vehicle, including the ADAS system, as the test vehicle is ran on the closed test track. This process generates an extensive log of data (“data log”) that describes the operation of every measurable aspect of the test vehicle, including the ADAS system. Most of the data included in the data log are not relevant to the operation of the ADAS system.

In theory, the data log can be analyzed by the automobile design engineers of the ADAS system to identify data relevant to the operation of the ADAS system (herein, “relevant data”). This relevant data can then be further analyzed by the automobile design engineers and compared to the specification of the ADAS system and the standards applicable to the ADAS to determine whether the ADAS system is functioning properly. If changes are needed, the automobile design engineers can modify parameters of the design of the ADAS system (either its hardware or software) so that the ADAS system functions more properly. A new prototype ADAS system is installed in the test vehicle tested once again used the closed test track process outlined above. In theory, this process is repeated until a prototype is found which functions properly.

The theory described in the preceding paragraph does not match reality. In reality, the data log is too exhaustive for efficient or accurate analysis. Because the data log includes data describing every moment when the vehicle is operated on the test track, and every measurable aspect of the vehicle in that moment, the entire data log can be many gigabytes or terabytes of data. Experience shows it is difficult or impossible for automobile design engineers to consider all the data included in the data log. As a result, it is (1) difficult for automobile design engineers to identify which information in the data log is relevant to the operation of the ADAS system and (2) impossible for the automobile design engineers to identify all the information in the data log that is relevant to the operation of the ADAS system. Analyzing the data log and devising a new ADAS prototype can take months or years, and even then it is possible that some information relevant to the operation of the ADAS system is missed by the automobile design engineers so that the final design is not as perfected as it could be.

Some solutions attempt to reduce the cost of developing a proper functioning ADAS system by using a simulation application to instead of a real-world closed test track to test and refine the design of the ADAS system. These solutions include a virtualized version of the test vehicle including a virtualized version of the ADAS system; the virtualized vehicle is then “ran” on a virtualized test track.

Although simulation applications may be cheaper than their real-world counterpart, all existing vehicle simulation applications suffer from the same fundamental problem as using a real-world test track: they generate massive data logs which are too big and suffer from the same problems described above for real-world closed track testing.

Accordingly, there is a need for improving the operation of a simulation application so that ADAS system designs can be more quickly and accurately improved so that they conform to their specifications and relevant standards.

### SUMMARY

A logging system is described herein that improves the performance of a simulation application by reducing the amount of data that is logged during simulations that test the operation of a vehicle control system such as an ADAS system.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method for limiting data logged for a simulation that is operable to test a performance of a virtual control system included in a virtual vehicle, the method including: executing a simulation for testing a performance of a virtual control system included in a virtual vehicle, where the simulation includes a plurality of frames visually displayed on a display panel and the plurality of frames visually depict the virtual vehicle moving in a virtual roadway environment having a dynamic object; assigning a monitored area around the virtual vehicle moving in the virtual roadway environment, where the monitored area is a subset of the virtual roadway environment that includes the virtual vehicle and the monitored area dynamically moves with the virtual vehicle as the virtual vehicle moves within the virtual roadway environment; monitoring the monitored area as the plurality of frames are visually displayed on the display panel; determining, for a particular frame of the plurality of frames, that a critical period is occurring in the particular frame based on a presence of the dynamic object in the monitored area during the particular frame; and storing critical period data that is limited so that the critical period data consists of a description of a set of features that are present in the simulation during the particular frame when the critical period is occurring. Other embodiments of this aspect include corresponding computer systems, apparatus, and computer programs recorded on one or more computer storage devices, each configured to perform the actions of the methods.

Implementations may include one or more of the following features. The method where the set of features are selected from a group that includes one or more of the following: a frame identifier of the particular frame; a scenario input associated with the particular frame; a dynamic object identifier of the dynamic object present in the monitored area for the particular frame; relative speed data that describes a difference in speed between the virtual vehicle and the dynamic object present in the monitored area for the particular frame; relative distance data that describes a distance between the virtual vehicle and the dynamic object present in the monitored area for the particular frame; one or more ADAS features being provided by the virtual control system at a time of the particular frame; and data that describes how the virtual control system responded to the presence of the dynamic object in the monitored area and one or more of the features included in the set of features. The method where the set of features consist of the following: a frame identifier of the particular frame; a scenario input associated with the particular frame; a dynamic object identifier of the dynamic object present in the monitored area for the particular frame; relative speed data that describes a difference in speed between the virtual vehicle and the dynamic object present in the monitored area for the particular frame; relative distance data that describes a distance between the virtual vehicle and the dynamic object present in the monitored area for the particular frame; and one or more ADAS features being provided by the virtual control system at a time of the particular frame. The method further including: determining, based on the critical period data, Graphical User Interface (“GUI”) data that is operable to cause the display panel to visual depict a second simulation of the critical period, where the second simulation visually depicts the virtual roadway environment during the critical period, the dynamic object present in the monitored area during the critical period and how the virtual vehicle responded to the dynamic object during the critical period; and providing the GUI data to the display panel so that the second simulation is visually depicted on the display panel. The method further including receiving an input describing a modification for a software model for the virtual control system based on how the virtual vehicle responded to the dynamic object during the critical period as visually depicted on the display panel during the second simulation, where the software model includes data that controls how the virtual vehicle responded to the dynamic object during the critical period. The method where the critical period data is stored in a data log that includes critical period data for a plurality of critical periods. The method where the data log is stored in a cloud server. Implementations of the described techniques may include hardware, a method or process, or computer software on a computer-accessible medium.

One general aspect includes a system including a processor communicatively coupled to a non-transitory memory and a display panel, where the non-transitory memory stores computer code which, when executed by the processor causes the processor to: execute a simulation for testing a performance of a virtual control system included in a virtual vehicle, where the simulation includes a plurality of frames visually displayed on a display panel and the plurality of frames visually depict the virtual vehicle moving in a virtual roadway environment having a dynamic object; assign a monitored area around the virtual vehicle moving in the virtual roadway environment, where the monitored area is a subset of the virtual roadway environment that includes the virtual vehicle and the monitored area dynamically moves with the virtual vehicle as the virtual vehicle moves within the virtual roadway environment; monitor the monitored area as the plurality of frames are visually displayed on the display panel; determine, for a particular frame of the plurality of frames, that a critical period is occurring in the particular frame based on a presence of the dynamic object in the monitored area during the particular frame; and store, in the non-transitory memory, critical period data that is limited so that the critical period data consists of a description of a set of features that are present in the simulation during the particular frame when the critical period is occurring. Other embodiments of this aspect include corresponding computer systems, apparatus, and computer programs recorded on one or more computer storage devices, each configured to perform the actions of the methods.

Implementations may include one or more of the following features. The system where the set of features are selected from a group that includes one or more of the following: a frame identifier of the particular frame; a scenario input associated with the particular frame; a dynamic object identifier of the dynamic object present in the monitored area for the particular frame; relative speed data that describes a difference in speed between the virtual vehicle and the dynamic object present in the monitored area for the particular frame; relative distance data that describes a distance between the virtual vehicle and the dynamic object present in the monitored area for the particular frame; one or more ADAS features being provided by the virtual control system at a time of the particular frame; and data that describes how the virtual control system responded to the presence of the dynamic object in the monitored area and one or more of the features included in the set of features. The system where the set of features consists of the following: a frame identifier of the particular frame; a scenario input associated with the particular frame; a dynamic object identifier of the dynamic object present in the monitored area for the particular frame; relative speed data that describes a difference in speed between the virtual vehicle and the dynamic object present in the monitored area for the particular frame; relative distance data that describes a distance between the virtual vehicle and the dynamic object present in the monitored area for the particular frame; and one or more ADAS features being provided by the virtual control system at a time of the particular frame. The system further including: determining, based on the critical period data, GUI data that is operable to cause the display panel to visual depict a second simulation of the critical period, where the second simulation visually depicts the virtual roadway environment during the critical period, the dynamic object present in the monitored area during the critical period and how the virtual vehicle responded to the dynamic object during the critical period; and providing the GUI data to the display panel so that the second simulation is visually depicted on the display panel. The system further including receiving an input describing a modification for a software model for the virtual control system based on how the virtual vehicle responded to the dynamic object during the critical period as visually depicted on the display panel during the second simulation, where the software model includes data that controls how the virtual vehicle responded to the dynamic object during the critical period. The system where the critical period data is stored in a data log that includes critical period data for a plurality of critical periods.

One general aspect includes a computer program product including a non-transitory memory of a computer system storing computer-executable code that, when executed by a processor, causes the processor to: execute a simulation for testing a performance of a virtual control system included in a virtual vehicle, where the simulation includes a plurality of frames visually displayed on a display panel and the plurality of frames visually depict the virtual vehicle moving in a virtual roadway environment having a dynamic object; assign a monitored area around the virtual vehicle moving in the virtual roadway environment, where the monitored area is a subset of the virtual roadway environment that includes the virtual vehicle and the monitored area dynamically moves with the virtual vehicle as the virtual vehicle moves within the virtual roadway environment; monitor the monitored area as the plurality of frames are visually displayed on the display panel; determine, for a particular frame of the plurality of frames, that a critical period is occurring in the particular frame based on a presence of the dynamic object in the monitored area during the particular frame; and store, in the non-transitory memory, critical period data that is limited so that the critical period data consists of a description of a set of features that are present in the simulation during the particular frame when the critical period is occurring. Other embodiments of this aspect include corresponding computer systems, apparatus, and computer programs recorded on one or more computer storage devices, each configured to perform the actions of the methods.

Implementations may include one or more of the following features. The computer program product where the set of features are selected from a group that includes one or more of the following: a frame identifier of the particular frame; a scenario input associated with the particular frame; a dynamic object identifier of the dynamic object present in the monitored area for the particular frame; relative speed data that describes a difference in speed between the virtual vehicle and the dynamic object present in the monitored area for the particular frame; relative distance data that describes a distance between the virtual vehicle and the dynamic object present in the monitored area for the particular frame; one or more ADAS features being provided by the virtual control system at a time of the particular frame; and data that describes how the virtual control system responded to the presence of the dynamic object in the monitored area and one or more of the features included in the set of features. The computer program product where the set of features consists of the following: a frame identifier of the particular frame; a scenario input associated with the particular frame; a dynamic object identifier of the dynamic object present in the monitored area for the particular frame; relative speed data that describes a difference in speed between the virtual vehicle and the dynamic object present in the monitored area for the particular frame; relative distance data that describes a distance between the virtual vehicle and the dynamic object present in the monitored area for the particular frame; and one or more ADAS features being provided by the virtual control system at a time of the particular frame. The computer program product further including: determining, based on the critical period data, GUI data that is operable to cause the display panel to visual depict a second simulation of the critical period, where the second simulation visually depicts the virtual roadway environment during the critical period, the dynamic object present in the monitored area during the critical period and how the virtual vehicle responded to the dynamic object during the critical period; and providing the GUI data to the display panel so that the second simulation is visually depicted on the display panel. The computer program product further including receiving an input describing a modification for a software model for the virtual control system based on how the virtual vehicle responded to the dynamic object during the critical period as visually depicted on the display panel during the second simulation, where the software model includes data that controls how the virtual vehicle responded to the dynamic object during the critical period. The computer program product where the computer-executable code is operable so that the critical period data stored in the non-transitory memory is limited to only describing the critical period so that storage space in the non-transitory memory is preserved and the second simulation is limited so that only the critical period is depicted in the second simulation to thereby reduce review time of the second simulation and increase an accuracy of the modification relative to not limiting the critical period data. The computer program product where the critical period data comes from the simulation and does not come from an image captured in a real-world. Implementations of the described techniques may include hardware, a method or process, or computer software on a computer-accessible medium.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1A is a block diagram illustrating an operating environment for a logging system according to some embodiments.

FIG. 1B is a block diagram illustrating another operating environment for a logging system according to some embodiments.

FIG. 2 is a block diagram illustrating an example computer system including a logging system according to some embodiments.

FIGS. 3A and 3B are a flowchart of an example method for storing critical period data according to some embodiments.

FIG. 4 is a flowchart of an example method for providing a second simulation based on critical period data according to some embodiments.

FIG. 5 is a block diagram illustrating a frame of a non-critical period for an example lane change event and a frame of a critical period for the example lane change event according to some embodiments.

FIG. 6 is a block diagram illustrating a frame of a non-critical period for an example merging on ramp event and a frame of a critical period for the example merging on ramp event according to some embodiments.

FIG. 7 is a block diagram illustrating an example of a data log including critical period data for a plurality of frames of a simulation according to some embodiments.

### DETAILED DESCRIPTION

Examples of an ADAS system include one or more of the following elements of a vehicle: an adaptive cruise control (“ACC”) system; an adaptive high beam system; an adaptive light control system; an automatic parking system; an automotive night vision system; a blind spot monitor; a collision avoidance system; a crosswind stabilization system; a driver drowsiness detection system; a driver monitoring system; an emergency driver assistance system; a forward collision warning system; an intersection assistance system; an intelligent speed adaption system; a lane keep assistance (“LKA”) system; a pedestrian protection system; a traffic sign recognition system; a turning assistant; and a wrong-way driving warning system.

In some embodiments, the ADAS system includes any software or hardware included in the vehicle that makes that vehicle be an autonomous vehicle or a semi-autonomous vehicle.

A vehicle may include one or more ADAS systems. These ADAS systems may be referred to as a vehicle control system since they identify one or more factors (e.g., using one or more onboard vehicle sensors) affecting an ego vehicle (e.g., the vehicle having the ADAS system installed in it) and modify (or control) the operation of the ego vehicle to respond to these identified factors. ADAS system functionality may include the process of (1) identifying one or more factors affecting the ego vehicle and (2) modifying the operation of the ego vehicle, or some component of the ego vehicle, based on these identified factors.

For example, an ACC system installed and operational in an ego vehicle may identify that a subject vehicle being followed by the ego vehicle with the cruise control system engaged has increased or decreased its speed. The ACC system may modify the speed of the ego vehicle based on the change in speed of the subject vehicle, and the detection of this change in speed and the modification of the speed of the ego vehicle is an example the ADAS system functionality of the ADAS system.

Similarly, an ego vehicle may have a LKA system installed and operational in an ego vehicle may detect, using one or more external cameras of the ego vehicle, an event in which the ego vehicle is near passing a center yellow line which indicates a division of one lane of travel from another lane of travel on a roadway. The LKA system may provide a notification to a driver of the ego vehicle that this event has occurred (e.g., an audible noise or graphical display) or take action to prevent the ego vehicle from actually passing the center yellow line such as making the steering wheel difficult to turn in a direction that would move the ego vehicle over the center yellow line or actually moving the steering wheel so that the ego vehicle is further away from the center yellow line but still safely positioned in its lane of travel. The process of identifying the event and taking action responsive to this event is an example of the ADAS system functionality provided by the LKA system.

The other ADAS systems described above each provide their own examples of ADAS system functionalities which are known in the art, and so, these examples of ADAS system functionality will not be repeated here.

An ADAS system may be modeled using a Modelica-based vehicle simulation applications. Vehicle simulation applications such as CarSim (distributed by Mechanical Simulation Corporation or Ann Arbor, Mich.) and MapleSim (distributed by Maplesoft of Waterloo, Ontario) include code and routines that are operable, when executed by a processor, to generate one or more models of the hardware and software of a vehicle design (referred to herein as a “hardware model” and a “software model,” respectively). The hardware model and the software model for the vehicle design includes one or more ADAS systems included in the vehicle design. The vehicle simulation application is also operable to generate model for a roadway environment including one or more dynamic objects (referred to herein as a “roadway model”).

The vehicle simulation application also includes a gaming engine. The gaming engine may be a Unity-based gaming engine (such as the Unity game engine distributed by Unity Technology of San Francisco, Calif.), or any other gaming engine suitable for generating a simulation for testing the design of a vehicle using a virtual roadway environment.

The vehicle simulation application includes code and routines that is operable, when executed by the processor, to generate a digital simulation (referred to herein as a “simulation” or a “vehicle simulation”). The simulation including a virtual roadway environment (built based on one or more roadway environment models) that includes a virtual vehicle (built based on the hardware model and software model for the virtual vehicle, which are collectively referred to as a “vehicle model”) and one or more virtualized dynamic objects that operate within the roadway environment and, at times, act as obstacles for the one or more virtualized ADAS systems of the virtual vehicle. These dynamic objects may include, for example, other virtual vehicles, virtualized pedestrians, virtualized animals, virtualized traffic lights, virtualized environmental factors (wind, water, ice, variation of sun light, mud, other liquids), variation of the virtual roadway (curves, turns, elevation changes), variation of driving surface frictions within the virtual roadway environment, etc. Automobile design engineers use the simulation to test whether their vehicle designs, as represented by the vehicle model (which includes the software model and the hardware model for the vehicle design), operate in conformity with their expectations, specifications for the vehicle design and standards which are applicable to the vehicle design or the discrete elements of the vehicle design (such as the ADAS system, specifically).

A vehicle simulation application may be referred to as a “virtual simulation tool.” Examples of virtual simulation tools are described in U.S. patent application Ser. No. 15/135,135 filed on Apr. 21, 2016 and entitled “Wind Simulation Device,” the entirety of which is hereby incorporated by reference. This technology is also discussed in U.S. patent application Ser. No. 15/074,842 filed on Mar. 18, 2016 and entitled “Vehicle Simulation Device for Crowd-Sourced Vehicle Simulation Data,” the entirety of which is hereby incorporated by reference.

### Example Overview

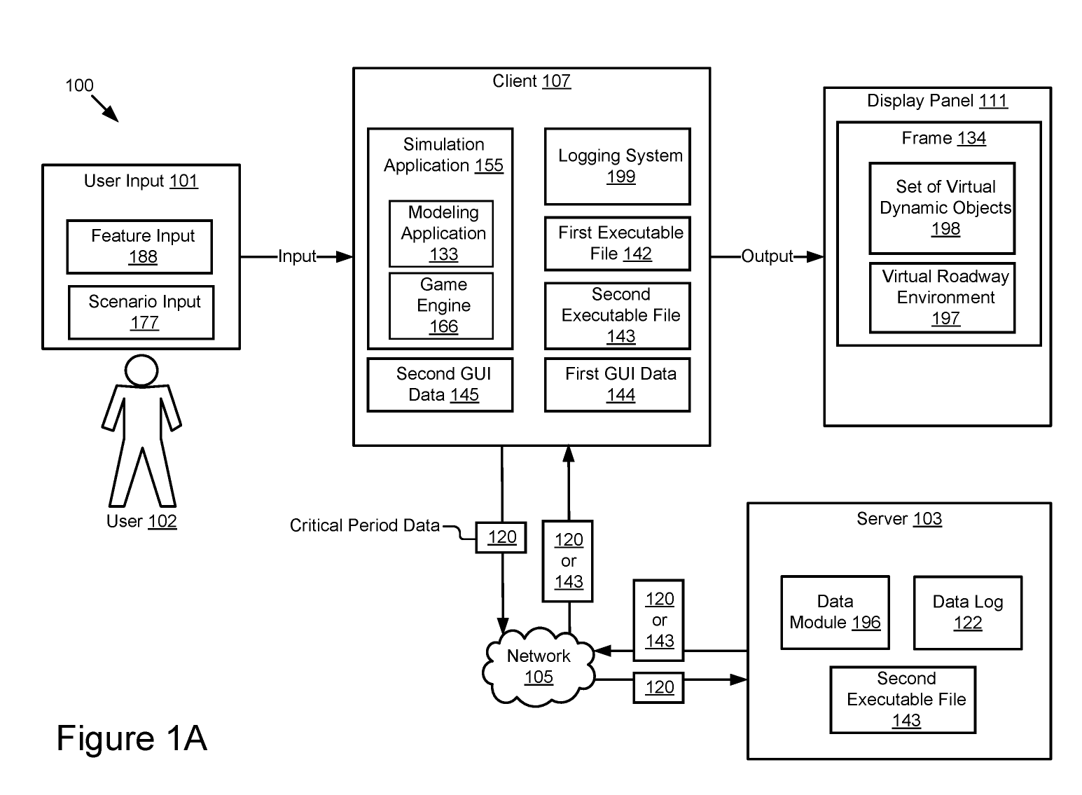

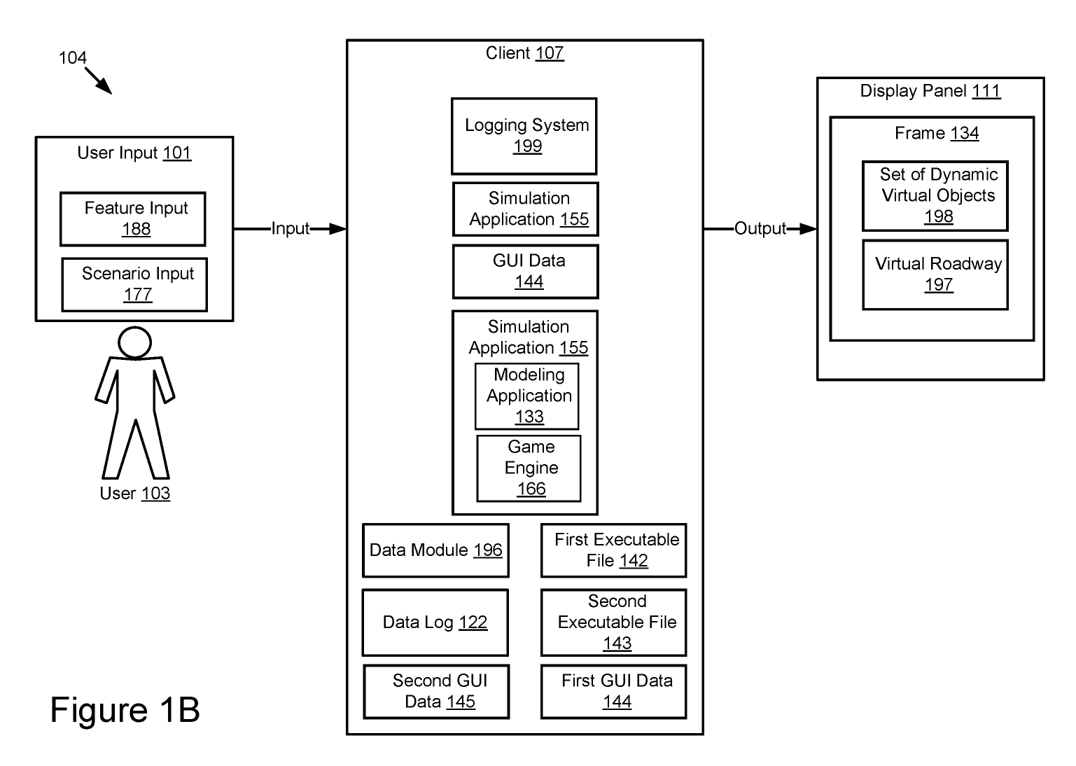

Referring to FIG. 1, depicted is a first operating environment 100 for a logging system 199. The first operating environment 100 may include one or more of the following elements: a client 107; a display panel 111; and a server 103. These elements of the first operating environment 100 may be communicatively coupled to a network 105.

The network 105 may be a conventional type, wired or wireless, and may have numerous different configurations including a star configuration, token ring configuration, or other configurations. Furthermore, the network 105 may include a local area network (LAN), a wide area network (WAN) (e.g., the Internet), or other interconnected data paths across which multiple devices and/or entities may communicate. In some embodiments, the network 105 may include a peer-to-peer network. The network 105 may also be coupled to or may include portions of a telecommunications network for sending data in a variety of different communication protocols. In some embodiments, the network 105 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, etc. The network 105 may also include a mobile data network that may include 3G, 4G, LTE, VoLTE or any other cellular network, mobile data network or combination of mobile data networks. Further, the network 105 may include one or more IEEE 802.11 wireless networks.

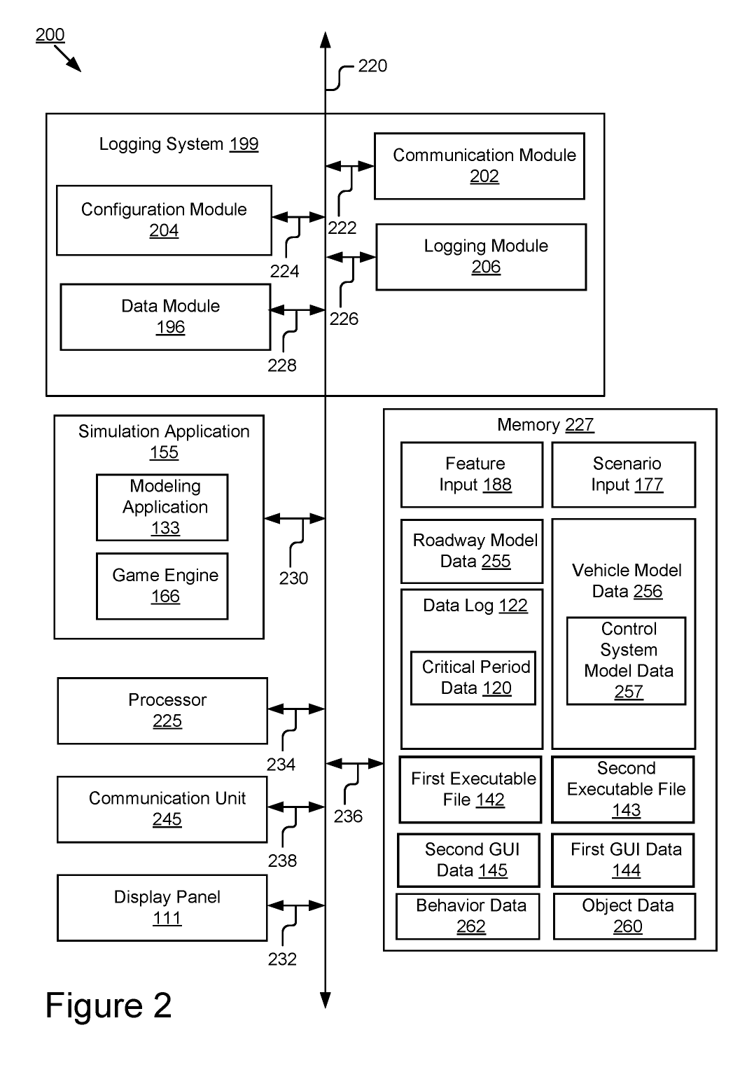

The client 107 is a processor-based computing device. For example, the client 107 is a personal computer, laptop, tablet-based computing device or some other processor-based computing device. The client 107 includes one or more of the following elements: a simulation application 155; a logging system 199; a first executable file 142; a second executable file 143; first GUI data 144; and second GUI data 145. These elements of the client 107 may be stored on a non-transitory memory (not pictured here, but see the memory 227 described below with reference to FIG. 2) that is accessible by a processor (not pictured here, but see the processor 225 described below with reference to FIG. 2).

The simulation application 155 may include a Modelica-based vehicle simulation application such as CarSim or some other Modelica-based vehicle simulation application that is operable to generate one or more models (e.g., the vehicle model, the roadway environment model, models for one or more dynamic objects and the behavior of these dynamic objects within the simulation, etc.) and provide a set of simulations based on these models. The set of simulations are configured to test a vehicle design to determine whether this design, and aspects of this design such as one or more vehicle control systems, operate in conformity with the expectations and specifications of the user 102 and one or more applicable standards.

In some embodiments, the simulation application 155 includes a modeling application 133 and a game engine 166. In some embodiments, the simulation application 155 may include one or more modeling applications 133 and one or more game engines 166.

The modeling application 133 may include software operable to generate the one or more models described above based on inputs provided by the user 102 or data received from the network 105. The simulation application 155 may include one or more modeling applications 133.

Different modeling applications 133 may be specialized for generating particular types of models. The hardware model and some of the software models for the vehicle design may be generated by a different modeling application 133 than the software model for the vehicle control system included in the vehicle design). For example, the simulation application 155 may include one or more of the following example modeling applications 133: Dymola (produced by Dassault Systemes AB, Lund of Velizy-Villacoublay, France, and used to generate a vehicle model); MapleSim (produced by Maplesoft of Waterloo, Ontario, and used to generate a vehicle model); Simulink (produced by MathWorks of Natick, Mass., and used to generate models of a vehicle control system); and PreScan (produced by TASS International of the Netherlands, and used to generate models of a vehicle control system), etc.

The game engine 166 may include code and routines that are operable, when executed by the processor of the client 107, to generate a simulation based on the one or more models generated by the one or more modeling applications 133. The game engine 166 may also include software for generating the vehicle roadway model based on inputs provided by the user 102 or other data uploaded to the client 107 (e.g., via the network 105 or some other data upload to the client 107 such as via a memory card or some other non-transitory memory). An example of the game engine 166 may include the Unity game engine (produced by Unity Technologies of San Francisco, Calif.) or some other game engine.

One or more of the game engine 166 and the modeling application 133 may generate the one or more models that describe the one or more dynamic objects and the behavior of these dynamic objects.

The game engine 166 may include software that is operable, when executed by the processor of the client 107, to compile an executable file based on the one or more models generated by the modeling application 133 and the game engine 166, as well as any models provided to the client 107 via the network 105 or a non-transitory memory (e.g., a model stored on a non-transitory memory of the client 107 or accessible by the client 107). The executable file may include one or more of the first executable file 142 and the second executable file 143. The executable file may be stored on the non-transitory memory of the client 107. The non-transitory memory may include a plurality of executable files.

An executable file may include code and routines that is operable, when executed by the processor of the client 107, to provide a simulation of the virtual vehicle in the virtual roadway environment when executed by a processor of the client 107. The virtual roadway environment includes one or more dynamic objects that operate in the virtual roadway environment; this operation, as well as other factors of the virtual roadway environment such as the environment, variations in the road and the driving surfaces, will cause one or more virtualized vehicle control systems of the virtual vehicle to respond (or not respond) in some way depending on whatever ADAS system functionality is provided by these particular virtualized vehicle control systems.

The first executable file 142 and the second executable file 143 are described in more detail below along with the first GUI data 144 and the second GUI data 145. The logging system 199 is described in more detail below with reference to FIG. 2 as well as the in relation to (1) a first simulation associated with the first executable file 142 and the first GUI data 144 and (2) a second simulation associated with the second executable file 143 and the second GUI data 145.

The user 102 is a human user of the client 107 and the display panel 111. The display panel 111 is communicatively coupled to the client 107 to receive data (e.g., the first GUI data 144 and the second GUI data 145) from the client 107.

In some embodiments, the user 102 may be an automobile design engineer. The user 102 provides one or more user inputs 101 to the client 107. The user 102 may provide these user inputs 101 via one or more peripherals (not pictured) that are communicatively coupled to the client 107 and adapted to provide the user input 101 to the client 107. For example, the user input 101 may be provided via one or more of a keyboard, mouse, microphone, camera sensor, etc.

In some embodiments, the user 102 uses the client 107 and the display panel 111 to execute the simulation application 155 and the logging system 199 to test the performance of one or more vehicle control systems included in a vehicle design. The vehicle design may include the hardware and software specifications for a vehicle that includes the one or more vehicle control systems. Referring to FIG. 2, the vehicle design is embodied in the vehicle model data 256 and the control system model data 257 depicted in FIG. 2. The vehicle model data 256 and the control system model data 257 are described in more detail below.

Referring back to FIG. 1A, the user 102 may use the simulation application 155 and the logging system 199 of the client 107 to test the vehicle design for a vehicle that includes one or more vehicle control systems. For example, the user 102 may test the performance of the one or more vehicle control systems included in the vehicle design using a set of simulations provided by the simulation application 155 and the logging system 199. These simulations may be provided, in part, in accordance with one or more user inputs 101 provided by the user 102.

The user input 101 includes a feature input 188 and a scenario input 177. The feature input 188 and the scenario input 177 may be included in the same user input 101 or in two or more different user inputs 101.

The feature input 188 may describe one or more ADAS features of the one or more vehicle control systems included in the vehicle design to be active during one or more of the simulations. A user 102 may specify that an ADAS feature is active so that it is tested and monitored by the simulation application 155 and the logging system 199 to determine whether it operates in conformity with its specification and applicable standards. For example, if a set of simulations is testing an operation of an ACC feature, then the feature input 188 specifies the ACC feature of a vehicle design as being active during the set of simulations so that the performance of the ACC feature may be tested by the simulation application 155 and monitored by the logging system 199.

As will be explained in more detail below, in some embodiments the testing and monitoring provided by the simulation application 155 focuses in particular on critical periods of the simulation in a way that is not done by other simulations. Focusing on these critical periods provides significantly more useful and accurate data for analysis by the user 102 which saves the user 102 time and enables them to provide an improved design of the vehicle control systems included in their vehicle design.

The scenario input 177 describes one or more scenarios to be included in one or more simulations which test the one or more ADAS features described by the feature input 188. A scenario may include a particular driving scenario which may be included in one or more simulations provided by the simulation application 155 for testing the one or more ADAS features. For example, a scenario may specify that the one or more ADAS features are to be tested on a curvy four lane road in an area with pedestrians when the road surface is wet and slippery and the traffic signal are malfunctioning. Such a scenario may be useful for testing many different types of ADAS features (e.g., the ADAS features of an ACC system or a LKA system or any other ADAS system designed to avoid collisions or provided increased safety).

A particular scenario input 177 may be associated with a particular feature input 188 so that the particular scenario input 177 defines one or more scenarios to be implemented by the simulation application 155 when testing the particular ADAS features described by the particular feature input 188.

The display panel 111 is any hardware device that is communicatively coupled to the client 107 and operable to visually depict data which is viewable by a user 102. The visually depicted data may include one or more frames 134 of a simulation. For example, a simulation provided by the simulation application 155 may include multiple frames 134 that are monitored by the logging system 199.

The simulation application 155 may cause the display panel to display a GUI which includes one or more graphical fields which the user 102 can use to provide the feature input 188 and the scenario input 177. The simulation application 155 may receive the feature input 188 and the scenario input 177 and provide a set of simulations based at least in part on these user inputs 101 so that the simulations are configured by the simulation application 155 in accordance with the user inputs 101 of the user 102. In this way one or more frames 134 are generated by the simulation application 155 based at least in part on a feature input 188 and a scenario input 177.

A frame 134 includes a set of virtual dynamic objects 198 and a virtual roadway environment 197. The set of virtual dynamic objects 198 includes a virtual vehicle that represents a vehicle design including one or more virtualized vehicle control systems, such as one or more virtualized ADAS systems, that are being tested in a set of simulations provided by the simulation application 155 as described in more detail below.

The set of virtual dynamic objects 198 includes the virtual vehicle whose vehicle design (include vehicle control system) is being tested by the first simulation as well as one or more other virtual dynamic objects such as other virtual vehicles, pedestrians, animals, traffic lights etc. The one or more vehicle control systems of the virtual vehicle may have to respond to these other virtual dynamic objects during the set of simulations.

The set of simulations includes a first simulation and a second simulation. As described in more detail below, the second simulation is generated based on the critical period data 120 produced by the logging system 199. The second simulation provides benefits that are not provided by other simulations generated by clients 107 that do not include the logging system 199. The second simulation is described in more detail below following the description of the first simulation.

In some embodiments, the first simulation includes a first test of the first designs for the one or more vehicle control systems of a vehicle design. A monitored area surrounds the virtual vehicle whose vehicle control systems are being tested by the first simulation. A frame of the first simulation is a part of a critical period if another virtual dynamic object enters the monitored area during that frame.

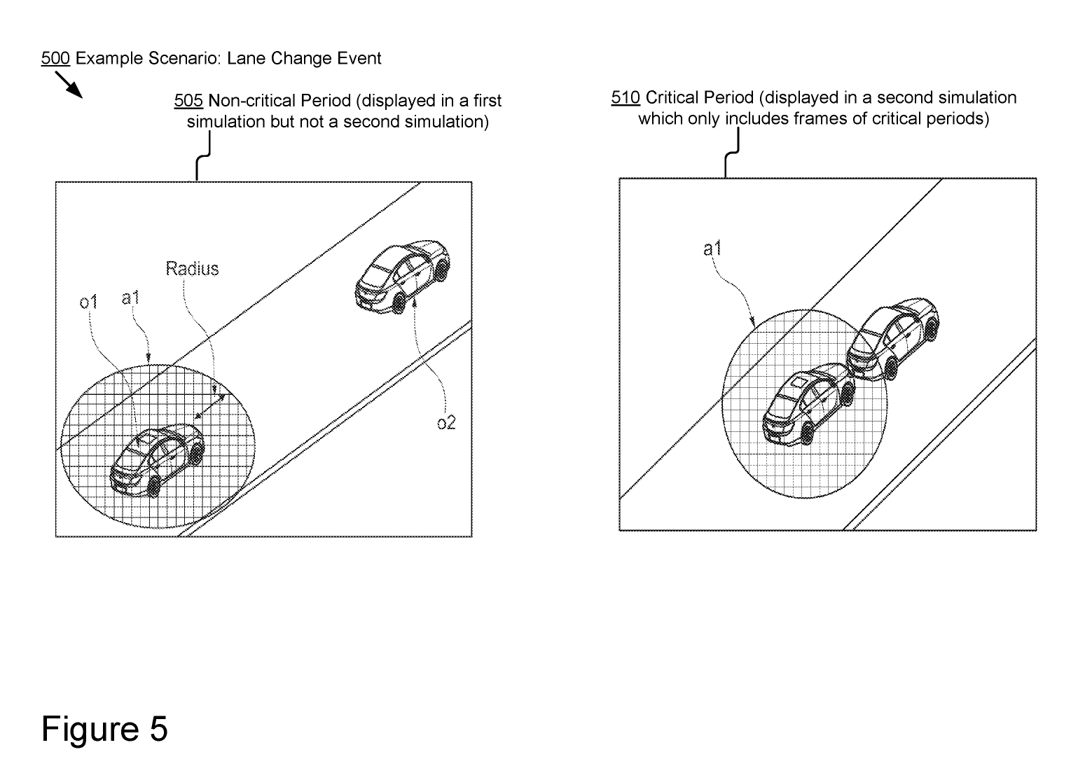

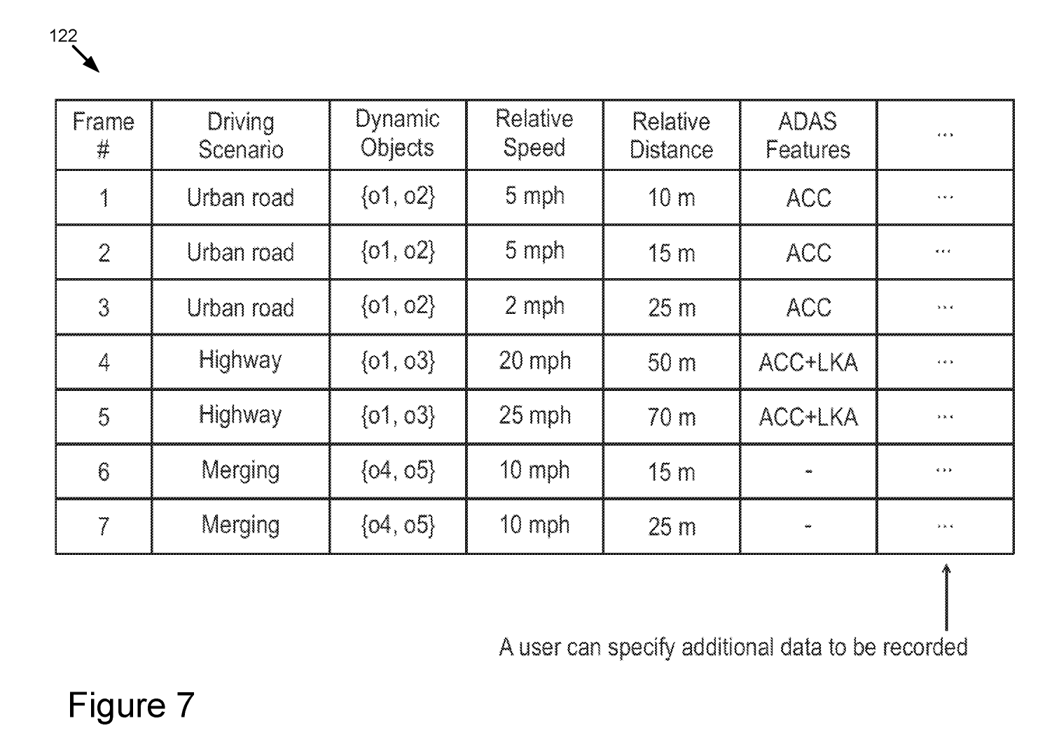

For example, with reference to FIG. 5, a non-critical frame 505 is a frame 134 where a non-critical period is occurring. Compare the non-critical frame 505 with the critical frame 510 depicted in FIG. 5 in which a critical period is occurring. Element “a1” represents a monitored area in FIG. 5. The monitored area “a1” is a geometric area within a virtual roadway environment that includes a first virtual dynamic object “o1.” The first virtual dynamic object “o1” is a virtual vehicle including one or more virtualized vehicle control systems that are being tested by a set of simulations. The non-critical frame 505 and the critical frame 510 also include a second virtual dynamic object “o2” which is not present in the monitored area in the non-critical frame 505 but is present in the monitored area in the critical frame 510. The critical frame 510 is a “critical period” because the second dynamic object “o2” is present in the monitored area “a1” in the critical frame 510. As described below in more detail, the logging system 199 monitors the monitored area “a1,” identifies the critical period and generates critical period data 120 which describes the critical frame 510 during the critical period. An example of the critical period data 120 for multiple critical frames (see, e.g., the frame numbers) is depicted in FIG. 7.

Referring back to FIG. 1A. The first simulation may include one or more critical periods. The one or more vehicle control systems may provide ADAS system functionality responsive to the presence of one or more second virtual dynamic objects “o2” in the monitored area “a1” during the first simulation. The logging system 199 may record critical period data 120 that describes, for each frame of the critical period, features of the virtual dynamic objects (e.g., “o1” and “o2”) included in the critical frames. The critical period data 120 may also describe how the one or more virtual vehicle control systems responded to the presence of the one or more second virtual dynamic objects “o2” being present in the monitored area “a1,” which in turn accurately reflects how real-world vehicle control systems represented by the one or more virtual vehicle control systems would actually perform in the real-world. In this way the set of simulations accurately test the operation of the one or more vehicle control systems included in the vehicle design being tested by the set of simulations.

The critical period data 120 generated by the first simulation may be aggregated to form a data log 122 which may be stored on a non-transitory memory of a server 103 or the client 107 itself (see, e.g., FIG. 1B where the data log 122 is stored on the client 107). The server 103 is described in more detail below. As described below, this critical period data 120 may be used to generate a second simulation which visually depicts the one or more critical periods of the first simulation. The second simulation does not include the non-critical periods of the first simulation.

The second simulation may be generated by the simulation application 155 (e.g., the game engine 166) based on the critical period data 120. In some embodiments, the user 102, who may be an automobile design engineer, views the second simulation using the display panel 111. The user 102 analyzes the second simulation to determine whether one or more virtual vehicle control systems of the virtual vehicle performed in compliance with their specifications and any standards that are applicable to their performance. The performance of the virtual vehicle control systems is reflected in the ADAS functionality provided by these systems during the one or more critical periods which are included in the second simulation.

In some embodiments, the user 102 may determine modifications for the design of the one or more vehicle control systems included in the vehicle design based on the analysis of the second simulation. If modifications are made, these modifications are reflected in one or more models built based on the modified vehicle design. The models which are modified responsive to the second simulation are described in more detail below with reference to the simulation application 155, the modeling application 133 and the game engine 166.

As described below in more detail, the first simulation is associated with the first executable file 142. A processor of the client 107 executes the first executable file 142. Responsive to its execution, the first executable file 142 causes the processor to generate the first GUI data 144 and provide the first GUI data 144 to the display panel 111. The first GUI data 144 causes the display panel 111 to visually depict a plurality of frames (such as the frame 134) which, viewed together, form the first simulation.

The processor of the client 107 executes the second executable file 143. Responsive to its execution, the second executable file 143 causes the processor to generate the second GUI data 144 and provide the second GUI data 145 to the display panel 111. The second GUI data 145 causes the display panel 111 to visually depict a plurality of frames (such as the frame 134) which, viewed together, form the second simulation.

As the first simulation occurs, the logging system 199 includes code and routines that are operable, when executed by the processor of the client 107, to monitor the performance of the virtual vehicle control system included in the virtual vehicle to generate critical period data 120 that describes, among other things, whether and how the virtual vehicle control system responded to events in the first simulation (such as other virtual dynamic objects) during one or more critical periods of the simulation.

The server 103 is a hardware server or a processor-based computing device that stores and executes server software. For example, the server 103 may include a personal computer, laptop, mainframe or some other processor-based computing device that is operable to send and receive messages via the network 105. The server 103 includes a non-transitory memory (not pictured) that stores the data module 196, the data log 122 and the second executable file 143. The non-transitory memory of the server 103 is accessible by the processor of the server 103. The processor of the server 103 accesses and executes the data module 196 stored in the non-transitory memory of the server 103.

The server 103 may be a cloud server. The server 103 may provide a service whereby the data module 196 receives the critical period data 120 from the network 105, generates the data log 122 based on the critical period data 120 and stores the data log 122 for the client 107. The server 103 may provide critical period data 120 to the client 107 from the data log 122 via the network 105 after having initially received the critical period data 120 from the client 107 via the network 105, which is then used to construct the data log 122.

In some embodiments, the data module 196 may analyze the critical period data 120 to generate a second executable file 143 which is then provided to a client 107 that does not include the data module 196.

The data log 122, such as the example data log 122 depicted in FIG. 7, may include a set of critical period data 120 that describe one or more critical frames.

The data module 196 may include code and routine that, when executed by the processor of the server 103, causes the processor to build the data log 122 based on the received critical period data 120. The data module 196, when executed by the processor of the server 103, causes the processor to analyze the data log 122 (or discrete instances of critical period data 120, to generate the second executable file 143. The second executable file 143 includes all the data necessary to generate a second simulation that only includes the critical periods which occurred in the first simulation. In this way, the second simulation may include a recap of the critical periods of the first simulation.

In some embodiments, the logging system 199 may be implemented using hardware including a field-programmable gate array (“FPGA”) or an application-specific integrated circuit (“ASIC”). In some other embodiments, the logging system 199 may be implemented using a combination of hardware and software. The logging system 199 may be stored in a combination of the devices (e.g., servers or other devices), or in one of the devices.

The logging system 199 is described in more detail below with reference to FIGS. 1B-7.

Referring now to FIG. 1B, depicted is a block diagram illustrating a second operating environment 104 for a logging system 199 according to some embodiments. In the second operating environment 104 the client 107 includes the data module 196 and the data log 122.

Referring now to FIG. 2, depicted is a block diagram illustrating an example computer system 200 including a logging system 199 according to some embodiments.

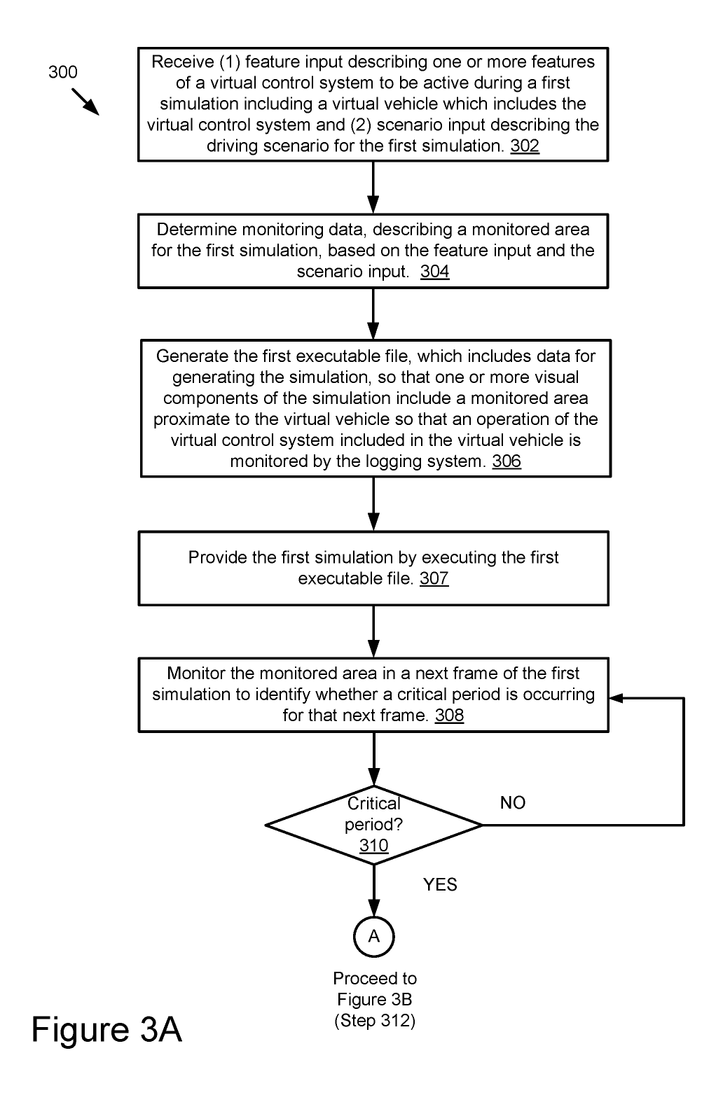

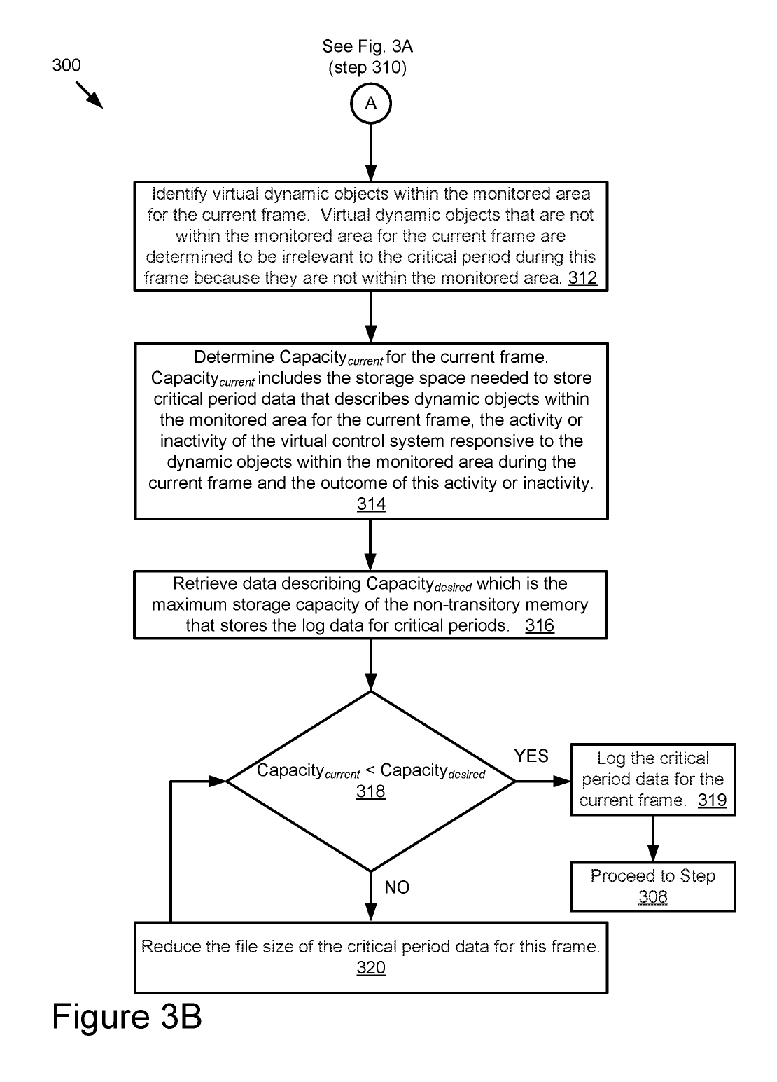

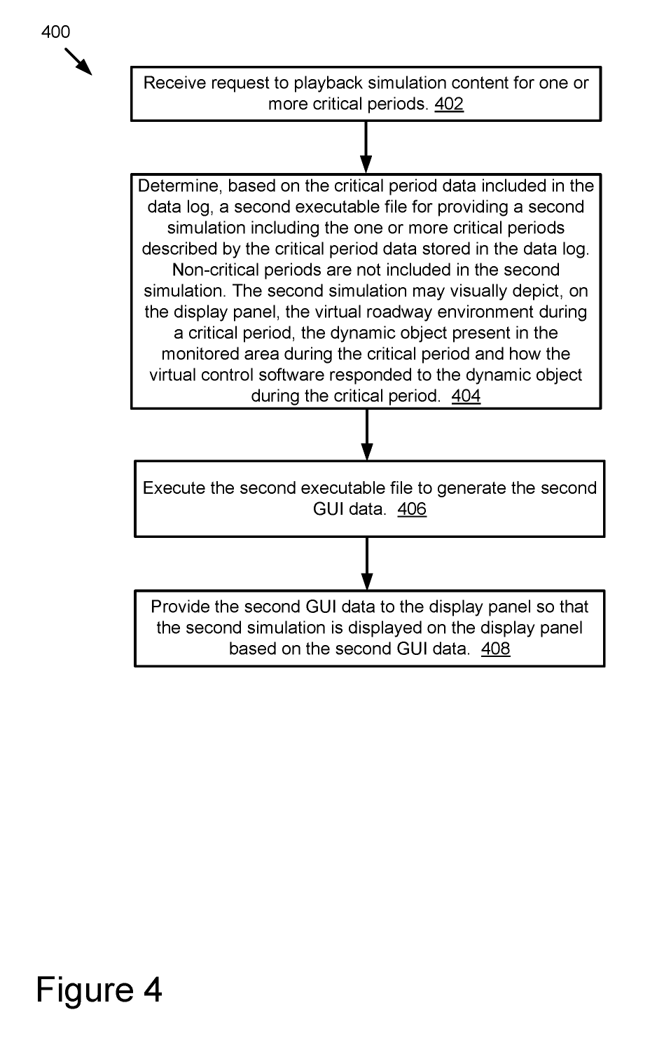

In some embodiments, the computer system 200 may include a special-purpose computer system that is programmed to perform one or more steps of the method 300 described below with reference to FIGS. 3A and 3B or the method 400 described below with reference to FIG. 4.

In some embodiments, the computer system 200 may be an element of one or more of the client 107 and the server 103.

The computer system 200 may include one or more of the following elements according to some examples: the logging system 199; a processor 225; a communication unit 245; a memory 227; the simulation application 155; and the display panel 111. The components of the computer system 200 are communicatively coupled by a bus 220.

In the illustrated embodiment, the processor 225 is communicatively coupled to the bus 220 via a signal line 234. The communication unit 245 is communicatively coupled to the bus 220 via a signal line 238. The memory 227 is communicatively coupled to the bus 220 via a signal line 236. The simulation application 155 is communicatively coupled to the bus 220 via a signal line 230. The display panel 111 is communicatively coupled to the bus 220 via a signal line 232.

The following elements of the computer system 200 were described above with reference to FIG. 1A, and so, those descriptions will not be repeated here: the simulation application 155; the modeling application 133; the game engine 166; and the display panel 111.

The processor 225 includes an arithmetic logic unit, a microprocessor, a general-purpose controller, or some other processor array to perform computations and provide electronic display signals to the display panel 111. The electronic display signals may include one or more if the first GUI data 144 and the second GUI data 145. The processor 225 processes data signals and may include various computing architectures including a complex instruction set computer (CISC) architecture, a reduced instruction set computer (RISC) architecture, or an architecture implementing a combination of instruction sets. Although FIG. 2 includes a single processor 225, multiple processors 225 may be included. The processor 225 may include a graphical processing unit. Other processors, operating systems, sensors, displays, and physical configurations may be possible.

The communication unit 245 may include hardware that transmits and receives data to and from the network 105. In some embodiments, the communication unit 245 includes a port for direct physical connection to the network 105 or to another communication channel. For example, the communication unit 245 includes a USB, SD, CAT-5, or similar port for wired communication with the network 105. In some embodiments, the communication unit 245 includes a wireless transceiver for exchanging data with the network 105 or other communication channels using one or more wireless communication methods, including IEEE 802.11, IEEE 802.16, Bluetooth®, or another suitable wireless communication method.

In some embodiments, the communication unit 245 includes a cellular communications transceiver for sending and receiving data over a cellular communications network including via short messaging service (SMS), multimedia messaging service (MMS), hypertext transfer protocol (HTTP), direct data connection, WAP, e-mail, or another suitable type of electronic communication. In some embodiments, the communication unit 245 includes a wired port and a wireless transceiver. The communication unit 245 also provides other conventional connections to the network 105 for distribution of files or media objects using standard network protocols including TCP/IP, HTTP, HTTPS, and SMTP, etc.

The memory 227 is a non-transitory storage medium that stores instructions or data that may be accessed and executed by the processor 225. The instructions or data may include code for performing the techniques described herein. The memory 227 may include a dynamic random access memory (DRAM) device, a static random access memory (SRAM) device, flash memory, or some other memory device. In some embodiments, the memory 227 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

As illustrated in FIG. 2, the memory 227 stores one or more of the following elements: the feature input 188; the scenario input 177; one or more sets of critical period data 120; the data log 122 (which may include the one or more sets of critical period data 120); the first executable file 142; the first GUI data 144; the second executable file 143; the second GUI data 145; roadway model data 255; control system model data 257; vehicle model data 256 (which may include the control system model data 257); the object data 260; and the behavior data 262.

The following elements of the memory 227 were described above with reference to FIG. 1A, and so, these descriptions will not be repeated here: the feature input 188; the scenario input 177; the critical period data 120; the data log 122; the first executable file 142; the first GUI data 144; the second executable file 143; and the second GUI data 145.

One or more of the following elements of the memory 227 may be included in one or more user inputs 101 and provided to the memory 227 by the user 102: the feature input 188; the scenario input 177; roadway model data 255; the vehicle model data 256; the object data 260; and the behavior data 262.

The roadway model data 255 may include data describing of one or more virtual roadway systems that are included in one or more of the simulations included in the set of simulations. For example, the roadway model data 255 may include data that describes the structure and physical properties of the one or more virtual roadway systems. The roadway model data 255 may be inputted to the computer system 200 via a set of user inputs 101 or generated by the simulation application 155. The roadway model data 255 may be generated by the simulation application 155 based at least in part on the scenario input 177. For example, the scenario input 177 may indicate a certain scenario, and the roadway model data 255 may describe one or more virtual roadway systems that conform or substantially conform to that scenario.

The vehicle model data 256 may include data describing of one or more virtual vehicles that are included in the simulation described by the GUI data 144. For example, the vehicle model data 256 may include data that describes the structure and physical properties of the one or more virtual vehicles. The vehicle model data 256 may be based on a vehicle design for a real-world vehicle or a vehicle that is proposed for creation in the real-world. The vehicle model data 256 operable to cause the virtual vehicle to accurately represent vehicle design.

The vehicle model data 256 may include control system model data 257. The control system model data 257 may describe the properties and behaviors of software that is operable in the vehicle described by the vehicle design. The control system model data 257 may describe one or more vehicle control systems. These vehicle control systems may be tested by the set of simulations provided by the simulation application 155. The control system model data 257 may be operable so that the virtual vehicle behaves in the simulation in a manner that is the same or similar to how a real-world vehicle built based on the vehicle model data 256 and the control system model data 257 would behave the real-world under the same or similar conditions. In this way, the logging system 199 may beneficially improve the performance of a vehicle built based on the vehicle design which includes the one or more vehicle control systems described by the control system model data 257.

The control system model data 257 include software for an autonomous vehicle. In this way, the logging system 199 may beneficially improve the performance of a vehicle such as an autonomous vehicle.

The feature input 188 may specify which ADAS features provided by the control systems described by the control system model data 257 are activated during a set of simulations. The simulation application 155 may limit the use of the control system model data 257 based on the feature input 188.

The control system model data 257 may describe all the software that is operable in the vehicle described by the vehicle design, and not just the one or more vehicle control systems included in the vehicle design.

The object data 260 describes one or more objects that are included in the set of simulations provided by the simulation application 155.

In some embodiments, the object data 260 describes one or more virtual static objects. A virtual static object may include any object in a simulation which does not move or is at least substantially non-dynamic. For example, the virtual static objects may include one or more of the following: a plant; a tree; a fire hydrant; a traffic sign; a roadside structure; a sidewalk; roadside equipment; etc.

In some embodiments, the one or more virtual static objects are included in the virtual roadway environment, and, as such, are described by the roadway model data 255.

In some embodiments, the object data 260 describes the one or more virtual dynamic objects. For example, the virtual dynamic objects described by the object data 260 may include one or more of the following: other virtual vehicles whose vehicle design is not being tested by the simulation application 155; virtualized pedestrians; virtualized animals; virtualized traffic lights; and virtualized environmental factors (wind, water, ice, variation of sun light, mud, other liquids); and other virtual dynamic objects included in a set of simulations.

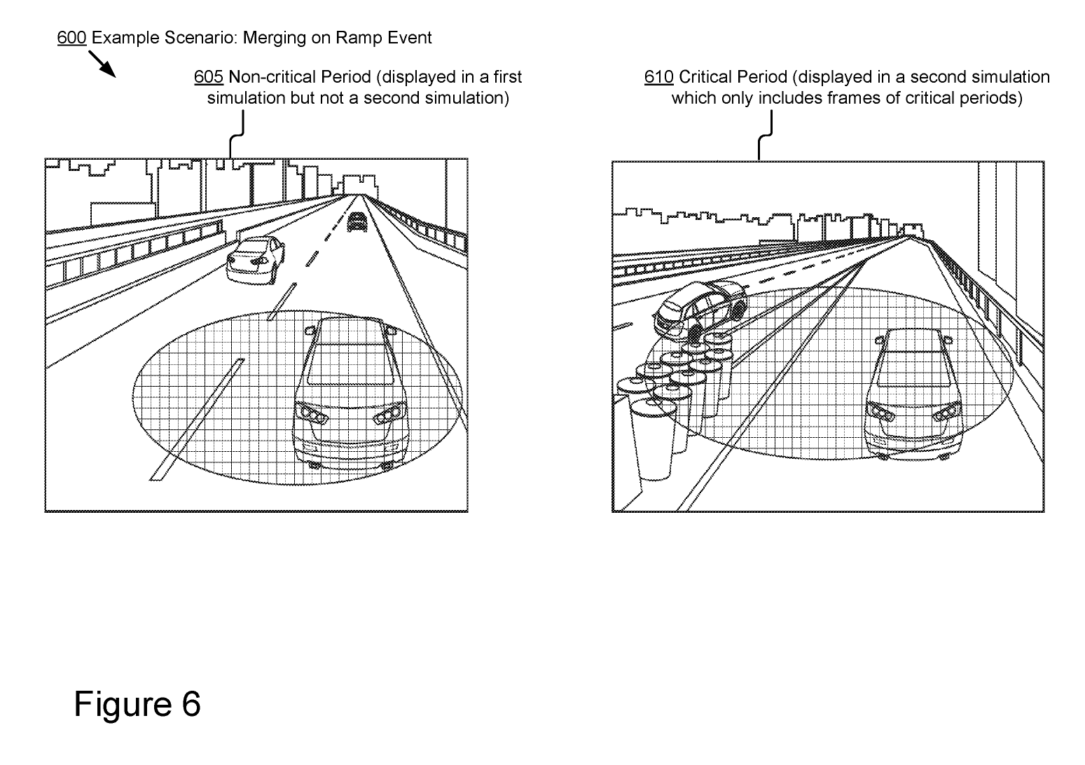

In some embodiments, the object data 260 describes the set of virtual dynamic objects 198 described above with reference to FIG. 1A. For example, the second virtual dynamic object “o2” described below with reference to FIGS. 5 and 6 may be described by the object data 260.

In some embodiments, the object data 260 includes digital data that is operable to cause the simulation application 155 to include the static and dynamic objects described by the object data 260 in the set of simulations provided by the simulation application 155.

The behavior data 262 describes the behavior of the one or more objects described by the object data 260. For example, the behavior data 262 describes the dynamic motion of the set of virtual dynamic objects 198 described by the object data 260.

In some embodiments, the behavior data 262 describes critical behavior of the set of virtual dynamic objects 198. For example, the behavior data 262 describes the movement of a virtual dynamic object into a monitored area. This movement into a monitored area is described in more detail below with reference to FIGS. 5 and 6.

In some embodiments, the behavior data 262 may be extracted by the computer system 200 based on an analysis of real-world roadway accidents performed by the computer system 200. In this way, the behavior data 262 may be configured so that the set of virtual dynamic objects 198 behave in a realistic fashion based on the actual behavior of real-world vehicles. The behavior may include the behavior that contributed to a roadway accident occurring in the real-world. For example, the critical behavior described by the behavior data 262 may include the “critical reason” for a roadway accident. In another example, the behavior described by the behavior data 262 may include the last behavior in a chain of behaviors that culminated in the roadway accident.

In some implementations, each object described by the object data 260 may be associated with a portion of the behavior data 262 that describes the behavior of that object. This portion of the behavior data 262 may specify that the object engage in critical behavior by entering a monitored area which is monitored by the logging system 199. The logging system 199 detects the presence of the object in the monitored area and generates the critical period data 120 for the one or more frames of the simulation in which the object is present in the monitored area as specified by the behavior data 262.

The behavior data 262 and its generation by an example of a computer system 200 is described in more detail in U.S. patent application Ser. No. 15/085,644 filed on Mar. 30, 2016 and entitled “Dynamic Virtual Object Generation for Testing Autonomous Vehicles in Simulated Driving Scenarios,” the entirety of which is hereby incorporated by reference. The computer system 200 described herein may be modified to include any of the elements described in U.S. patent application Ser. No. 15/085,644.

In some embodiments, the first executable file 142 may include one or more of the following elements: the roadway model data 255; the vehicle model data 256; the control system model data 257; the object data 260; and the behavior data 262. The processor 225 may execute the first executable file 142. The first executable file 142, responsive to being executed by the processor 225, may cause the processor 225 to generate the first GUI data 144 which includes graphical data for causing the display panel 111 to display a first simulation based on the elements of the first executable file 142. As this simulation occurs, the logging system 199 detects critical periods in one or more frames of the simulation. The logging system 199 generates the critical period data 120 and the data module 196 constructs the data log 122. The critical period data 120 includes all the data that is necessary for causing the data module 196 to generate the second executable file 143.

In some embodiments, the second executable file 143 may include a subset of the digital data included in the first executable file 142. For example, the second executable file 143 may include the roadway model data 255, the vehicle model data 256 and the control system model data 257 for generating a simulation which conforms (or substantially conforms) to the feature input 188 and the scenario input 177. The second executable file 143 may also include the object data 260 for objects viewable in a frame of the first simulation during a critical period (and only this critical period) and the behavior data 262 that corresponds to the behavior of these objects during the critical period (and only this critical period). In some embodiments, the object data 260 and the behavior data 262 included in the second executable file 143 by the data module 196 is limited to only the critical period so that the second simulation is always shorter than the first simulation. In some embodiments, data module 196 analyzes the critical period data 120 to extrapolate or interpolate new behavior data 262 for objects which can occur during the moments that separate different critical periods in the second simulation so that the flow of activity in the second simulation is smoother and easier to view by the user 102.

In some embodiments, the memory 227 stores any data necessary for the simulation application 155 to provide its functionality.

In the illustrated embodiment shown in FIG. 2, the logging system 199 includes a communication module 202, a configuration module 204, a logging module 206 and the data module 196. These components of the logging system 199 are communicatively coupled to each other via a bus 220. In some embodiments, components of the logging system 199 can be stored in a single server or device. In some other embodiments, components of the logging system 199 can be distributed and stored across multiple servers or devices. For example, some of the components of the logging system 199 may be distributed across the server 103 and the client 107.

The communication module 202 can be software including routines for handling communications between the logging system 199 and other components of the computer system 200. In some embodiments, the communication module 202 can be a set of instructions executable by the processor 225 to provide the functionality described below for handling communications between the logging system 199 and other components of the computer system 200.

The communication module 202 sends and receives data, via the communication unit 245, to and from one or more elements of the first operating environment 100 or second operating environment 104. For example, the communication module 202 receives or transmits, via the communication unit 245, one or more of the elements stored on the memory 227.

In some embodiments, the communication module 202 receives data from components of the logging system 199 and stores the data in the memory 227.

In some embodiments, the communication module 202 may handle communications between components of the logging system 199. For example, the communications module 202 may handle communications among the configuration module 204, the logging module 206 and the data module 196. Any of these modules may cause the communication module 202 to communicate with the other elements of the computer system 200, the first operating environment 100 or the second operating environment 104.

In some embodiments, the communication module 202 may receive one or more user inputs 101 via a peripheral communicatively coupled to the bus 220 (not pictured in FIG. 2) and the communication module 202 may store the data included in these user inputs 101 in the memory 227. For example, the communication module 202 may store the feature input 188 and the scenario input 177 in the memory 227. The communication module 202 may transmit these user inputs 101 to the configuration module 204 which may generate the first executable file 142 based in part on the user inputs 101.

In some embodiments, the communication module 202 can be stored in the memory 227 of the computer system 200 and can be accessible and executable by the processor 225. The communication module 202 may be adapted for cooperation and communication with the processor 225 and other components of the computer system 200 via signal line 222.

The configuration module 204 can be software including routines for generating the first executable file 142 based on the data stored in the memory 227. For example, the configuration module 204 may receive the feature input 188 and the scenario input 177 from the communication module 202 and then generate the first executable file based on these user inputs 101 as well as other data stored in the memory 227.

In some embodiments, the configuration module 204 may define the monitored area for the first simulation based at least in part on the user input 102. For example, the monitored area defined by the configuration module 204 may have a different shape depending on the scenario included in the first simulation and the ADAS features activated during the test. For example, if the scenario input 177 specifies a highway scenario, the configuration module 204 determines that monitored area is relatively large compared to an urban scenario since keeping the short distance in the highway scenario is more likely to cause crashing scenarios since the virtual vehicle control system is operable when another virtual dynamic object is present in the monitored area.

In another example, the feature input 188 may specify that the ADAS functionality of a pre-collision system is activated. In this example, the monitored area may be a circular shape with a radius of 30 meters. In this example the monitored area may be determined by the configuration module 204 to be this size and shape base on the fact that the pre-collision system is being tested and a table or some other dataset stored in the memory 227 specifies this shape and size for the testing of this ADAS feature. The table or dataset may specify other shapes and other sizes for other ADAS features.

In some embodiments, the user input 101 may include data that explicitly defines the size and shape of the monitored area. For example, the size and shape of the monitored area may be a component of the scenario input 177.

In some embodiments, the configuration module 204 can be stored in the memory 227 of the computer system 200 and can be accessible and executable by the processor 225. The configuration module 204 may be adapted for cooperation and communication with the processor 225 and other components of the computer system 200 via the signal line 224.

The logging module 206 can be software including routines monitoring the monitored area for the presence of dynamic virtual objects (excluding the virtual vehicle itself which is the subject of the test), determining the occurrence of a critical period within a frame based on the presence of such dynamic virtual objects in the monitored area during the frame and generating the critical period data 120 that describes the frame during the critical period.

For example, if any virtual dynamic object enters the monitored area, the logging module 206 detects the presence of the virtual dynamic object and starts recording critical period data 120 for inclusion in the data log 122. The critical period data 120 for a particular frame may describe what happens within the monitored area during the frame which is part of a critical period. The logging module 206 does not collect or generate any critical period data 120 for frames that are not part of a critical period.

The logging module 206 may also include software for monitoring the size of the memory 227 and generating critical period data 120 whose file size is customized based on the amount of storage space available in the memory 227. This functionality of the logging module 206 is described in more detail below with reference to FIG. 3B (steps 314, 316, 318 and 320).

In some embodiments, the logging module 206 can be stored in the memory 227 of the computer system 200 and can be accessible and executable by the processor 225. The logging module 206 may be adapted for cooperation and communication with the processor 225 and other components of the computer system 200 via the signal line 226.

The data module 196 was described above with reference to FIG. 1A, and so, that description will not be repeated here. The data module 196 may generate the second executable file based in part on the critical period data 120 generated for the first simulation. The data module 196 may also include software for executing the steps of the method 400 described below with reference to FIG. 4.

In some embodiments, the data module 196 can be stored in the memory 227 of the computer system 200 and can be accessible and executable by the processor 225. The data module 196 may be adapted for cooperation and communication with the processor 225 and other components of the computer system 200 via the signal line 228.

Referring now to FIGS. 3A and 3B, depicted is a flowchart of an example method 300, according to some embodiments, for storing critical period data according to some embodiments. One or more of the steps described herein for the method 300 may be executed by one or more logging systems. In some embodiments, one or more of the steps for the method 300 are executed by the processor 225 of the computer system 200 described above with reference to FIG. 2.

Referring to FIG. 3A, at step 302, a user input is received. The user input may include the feature input and a scenario input. A first simulation may be generated based at least in part on the feature input and the scenario input.

At step 304, a monitored area is determined for a first simulation based in part on the user input.

At step 306, the first executable file may be generated. Execution of the first configuration file may provide the first simulation. The first executable file may be generated based in part on the user inputs received in step 302 and the monitored area determined at step 304.

At step 307, the first executable file is generated. Executing of the first executable file provides the first simulation.

At step 308, the monitored area is monitored for a next frame of the first simulation to identify whether a critical period is occurring for that next frame.

At step 310, a determination is made regarding whether a critical period is occurring in the next frame. If a critical period is not occurring at step 310, then the method 300 proceeds to step 308. If a critical period is occurring at step 310, then the method 300 proceeds to step 312.

Referring now to FIG. 3B, at step 312, one or more virtual dynamic objects within the monitored area for the current frame are identified. Virtual dynamic objects that not within the monitored area for the current frame are determined to be irrelevant to the critical period during this frame because they are not within the monitored area.

At step 314, Capacity_{current} for the current frame is determined. Capacity_{current} includes the storage space needed to store critical period data that describes dynamic objects within the monitored area for the current frame, the activity or inactivity of the virtual control system responsive to the dynamic objects within the monitored area during the current frame and the outcome of this activity or inactivity. The data module 196 may include code and routines that are operable, when executed by the processor 225, to execute this step 314 of the method 300.

At step 316, data describing Capacity_{desired}, which is the maximum storage capacity of the non-transitory memory that stores the log data for critical periods, is retrieved from the non-transitory memory. For example, the memory 227 may store data that describes the maximum storage capacity of the memory 227 and this data may be retrieved from the memory 227 at step 316.

At step 318, a determination is made regarding whether Capacity_{current} is less than Capacity_{desired}. If Capacity_{current} is determined to be less than (or equal to) Capacity_{desired} at step 318, then the method 300 proceeds to step 319. If Capacity_{current} is determined to be more than Capacity_{desired} at step 318, then the method 300 proceeds to step 320.

At step 320, the file size of the critical period data is reduced. For example, the method 300 some of the data describing events within the monitored area may be “dropped,” i.e., not included in the critical period data to be generated for the frame. In some embodiments, the data module 196 may include a hierarchy that specifies the most important data for any particular critical period, and the data module 196 may dynamically generate critical period data 120 for this particular frame based in part on this hierarchy and the amount of space available in the memory 227. In some implementations, the data dropped by the data module 196 may be identified at random such that the available storage space in the memory 227 is utilized as well as possible. There may be some predetermined storage threshold for Capacity_{desired} that triggers this action by the data module 196. This threshold may include Capacity_{desired} being equal to 500 megabytes, 1 gigabyte or some other value specified by the user 102.

After step 310 the method 300 proceeds to step 318 once again.

At step 319, the critical period data is generated and optionally stored in the data log. Following step 308, the method 300 proceeds to step 308 for the next frame of the first simulation.

Referring now to FIG. 4, depicted is a flowchart of a method 400 for providing a second simulation based on critical period data generated by the method 300 according to some embodiments.

At step 402, a request to playback simulation content for one or more critical periods is received. For example, the user 102 may provide a user input requesting the second simulation.

At step 404, the method 400 determines, based on the critical period data included in the data log, a second executable file for providing a second simulation including the one or more critical periods described by the critical period data stored in the data log. Non-critical periods are not included in the second simulation. The second simulation may visually depict, on the display panel, the virtual roadway environment during a critical period, the dynamic object present in the monitored area during the critical period and how the virtual control software responded to the dynamic object during the critical period.

At step 406, the second executable file is executed thereby generating the second GUI data.

At step 408, the second GUI data is provided to the display panel.

Referring now to FIG. 5, depicted is a block diagram illustrating a frame 505 of a non-critical period for an example lane change event 500 and a frame 510 of a critical period for the example lane change event 500 according to some embodiments.

Element “o1” is the virtual vehicle whose virtual control software is the subject of the test being performed by a first simulation. In some embodiments, the first simulation may include multiple virtual vehicles as the subject of the test. Element “a1” is the monitored area. In FIG. 5, the monitored area is circular shaped and has a radius. Element “o2” is virtual dynamic object which is not present in the monitored area.

Referring to FIG. 6, depicted is a block diagram illustrating a frame 605 of a non-critical period for an example merging on ramp event 600 and a frame 610 of a critical period for the example merging on ramp event according to some embodiments. In the critical period a virtual dynamic object, here another virtual vehicle, is located within the monitored area.

Referring to FIG. 7, depicted is a block diagram illustrating an example of a data log 122 including critical period data 120 for a plurality of frames of a simulation according to some embodiments. Each row of the data log 122 includes a different set of critical period data for a different frame of a first simulation.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the present embodiments can be described above primarily with reference to user interfaces and particular hardware. However, the present embodiments can apply to any type of computer system that can receive data and commands, and any peripheral devices providing services.

Reference in the specification to “some embodiments” or “some instances” means that a particular feature, structure, or characteristic described in connection with the embodiments or instances can be included in at least one embodiment of the description. The appearances of the phrase “in some embodiments” in various places in the specification are not necessarily all referring to the same embodiments.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present embodiments of the specification can also relate to an apparatus for performing the operations herein. This apparatus may be specially constructed for the required purposes, or it may include a general-purpose computer selectively activated or reconfigured by a computer program stored in the computer. Such a computer program may be stored in a computer-readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some preferred embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited, to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem, and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the embodiments of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions, or formats. Furthermore, as will be apparent to one of ordinary skill in the relevant art, the modules, routines, features, attributes, methodologies, and other aspects of the disclosure can be implemented as software, hardware, firmware, or any combination of the three. Also, wherever a component, an example of which is a module, of the specification is implemented as software, the component can be implemented as a standalone program, as part of a larger program, as a plurality of separate programs, as a statically or dynamically linked library, as a kernel-loadable module, as a device driver, or in every and any other way known now or in the future to those of ordinary skill in the art of computer programming. Additionally, the disclosure is in no way limited to embodiment in any specific programming language, or for any specific operating system or environment. Accordingly, the disclosure is intended to be illustrative, but not limiting, of the scope of the specification, which is set forth in the following claims.

What is claimed is:

1. A method for limiting data logged for a simulation that is operable to test a performance of a virtual control system included in a virtual vehicle, the method comprising:
executing a simulation for testing a performance of a virtual control system included in a virtual vehicle, wherein the simulation includes a plurality of frames visually displayed on a display panel and the plurality of frames visually depict the virtual vehicle moving in a virtual roadway environment having a dynamic object;
assigning a monitored area around the virtual vehicle moving in the virtual roadway environment, wherein the monitored area is a subset of the virtual roadway environment that includes the virtual vehicle and the monitored area dynamically moves with the virtual vehicle as the virtual vehicle moves within the virtual roadway environment;
monitoring the monitored area as the plurality of frames are visually displayed on the display panel;
determining, for a particular frame of the plurality of frames, that a critical period is occurring in the particular frame based on a presence of the dynamic object in the monitored area during the particular frame; and
storing critical period data that is limited so that the critical period data consists of a description of a set of features that are present in the simulation during the particular frame when the critical period is occurring.

2. The method of claim 1, wherein the set of features are selected from a group that includes one or more of the following:
a frame identifier of the particular frame;
a scenario input associated with the particular frame;
a dynamic object identifier of the dynamic object present in the monitored area for the particular frame;
relative speed data that describes a difference in speed between the virtual vehicle and the dynamic object present in the monitored area for the particular frame;
relative distance data that describes a distance between the virtual vehicle and the dynamic object present in the monitored area for the particular frame;
one or more Adaptive Driving Assistance System (“ADAS”) features being provided by the virtual control system at a time of the particular frame; and
data that describes how the virtual control system responded to the presence of the dynamic object in the monitored area and one or more of the features included in the set of features.

3. The method of claim 1, wherein the set of features consist of the following:
a frame identifier of the particular frame;
a scenario input associated with the particular frame;
a dynamic object identifier of the dynamic object present in the monitored area for the particular frame;
relative speed data that describes a difference in speed between the virtual vehicle and the dynamic object present in the monitored area for the particular frame;
relative distance data that describes a distance between the virtual vehicle and the dynamic object present in the monitored area for the particular frame; and
one or more ADAS features being provided by the virtual control system at a time of the particular frame.

4. The method of claim 1, further comprising:
determining, based on the critical period data, Graphical User Interface (“GUI”) data that is operable to cause the display panel to visual depict a second simulation of the critical period, wherein the second simulation visually depicts the virtual roadway environment during the critical period, the dynamic object present in the monitored area during the critical period and how the virtual vehicle responded to the dynamic object during the critical period; and
providing the GUI data to the display panel so that the second simulation is visually depicted on the display panel.

5. The method of claim 4, further comprising receiving an input describing a modification for a software model for the virtual control system based on how the virtual vehicle responded to the dynamic object during the critical period as visually depicted on the display panel during the second simulation, wherein the software model includes data that controls how the virtual vehicle responded to the dynamic object during the critical period.

6. The method of claim 1, wherein the critical period data is stored in a data log that includes critical period data for a plurality of critical periods.

7. The method of claim 6, wherein the data log is stored in a cloud server.

8. A system including a processor communicatively coupled to a non-transitory memory and a display panel, wherein the non-transitory memory stores computer code which, when executed by the processor causes the processor to:
execute a simulation for testing a performance of a virtual control system included in a virtual vehicle, wherein the simulation includes a plurality of frames visually displayed on a display panel and the plurality of frames visually depict the virtual vehicle moving in a virtual roadway environment having a dynamic object;
assign a monitored area around the virtual vehicle moving in the virtual roadway environment, wherein the monitored area is a subset of the virtual roadway environment that includes the virtual vehicle and the monitored area dynamically moves with the virtual vehicle as the virtual vehicle moves within the virtual roadway environment;
monitor the monitored area as the plurality of frames are visually displayed on the display panel;
determine, for a particular frame of the plurality of frames, that a critical period is occurring in the particular frame based on a presence of the dynamic object in the monitored area during the particular frame; and
store, in the non-transitory memory, critical period data that is limited so that the critical period data consists of a description of a set of features that are present in the simulation during the particular frame when the critical period is occurring.

9. The system of claim 8, wherein the set of features are selected from a group that includes one or more of the following:
a frame identifier of the particular frame;
a scenario input associated with the particular frame;
a dynamic object identifier of the dynamic object present in the monitored area for the particular frame;
relative speed data that describes a difference in speed between the virtual vehicle and the dynamic object present in the monitored area for the particular frame;
relative distance data that describes a distance between the virtual vehicle and the dynamic object present in the monitored area for the particular frame;
one or more ADAS features being provided by the virtual control system at a time of the particular frame; and
data that describes how the virtual control system responded to the presence of the dynamic object in the monitored area and one or more of the features included in the set of features.

10. The system of claim 8, wherein the set of features consist of the following:
a frame identifier of the particular frame;
a scenario input associated with the particular frame;
a dynamic object identifier of the dynamic object present in the monitored area for the particular frame;
relative speed data that describes a difference in speed between the virtual vehicle and the dynamic object present in the monitored area for the particular frame;
relative distance data that describes a distance between the virtual vehicle and the dynamic object present in the monitored area for the particular frame; and
one or more ADAS features being provided by the virtual control system at a time of the particular frame.

11. The system of claim 8, further comprising:
determining, based on the critical period data, GUI data that is operable to cause the display panel to visual depict a second simulation of the critical period, wherein the second simulation visually depicts the virtual roadway environment during the critical period, the dynamic object present in the monitored area during the critical period and how the virtual vehicle responded to the dynamic object during the critical period; and
providing the GUI data to the display panel so that the second simulation is visually depicted on the display panel.

12. The system of claim 11, further comprising receiving an input describing a modification for a software model for the virtual control system based on how the virtual vehicle responded to the dynamic object during the critical period as visually depicted on the display panel during the second simulation, wherein the software model includes data that controls how the virtual vehicle responded to the dynamic object during the critical period.

13. The system of claim 8, wherein the critical period data is stored in a data log that includes critical period data for a plurality of critical periods.

14. A computer program product comprising a non-transitory memory of a computer system storing computer-executable code that, when executed by a processor, causes the processor to:
execute a simulation for testing a performance of a virtual control system included in a virtual vehicle, wherein the simulation includes a plurality of frames visually displayed on a display panel and the plurality of frames visually depict the virtual vehicle moving in a virtual roadway environment having a dynamic object;
assign a monitored area around the virtual vehicle moving in the virtual roadway environment, wherein the monitored area is a subset of the virtual roadway environment that includes the virtual vehicle and the monitored area dynamically moves with the virtual vehicle as the virtual vehicle moves within the virtual roadway environment;
monitor the monitored area as the plurality of frames are visually displayed on the display panel;
determine, for a particular frame of the plurality of frames, that a critical period is occurring in the particular frame based on a presence of the dynamic object in the monitored area during the particular frame; and
store, in the non-transitory memory, critical period data that is limited so that the critical period data consists of a description of a set of features that are present in the simulation during the particular frame when the critical period is occurring.

15. The computer program product of claim 14, wherein the set of features are selected from a group that includes one or more of the following:
a frame identifier of the particular frame;
a scenario input associated with the particular frame;
a dynamic object identifier of the dynamic object present in the monitored area for the particular frame;
relative speed data that describes a difference in speed between the virtual vehicle and the dynamic object present in the monitored area for the particular frame;
relative distance data that describes a distance between the virtual vehicle and the dynamic object present in the monitored area for the particular frame;
one or more ADAS features being provided by the virtual control system at a time of the particular frame; and
data that describes how the virtual control system responded to the presence of the dynamic object in the monitored area and one or more of the features included in the set of features.

16. The computer program product of claim 14, wherein the set of features consist of the following:
a frame identifier of the particular frame;
a scenario input associated with the particular frame;
a dynamic object identifier of the dynamic object present in the monitored area for the particular frame;
relative speed data that describes a difference in speed between the virtual vehicle and the dynamic object present in the monitored area for the particular frame;
relative distance data that describes a distance between the virtual vehicle and the dynamic object present in the monitored area for the particular frame; and
one or more ADAS features being provided by the virtual control system at a time of the particular frame.

17. The computer program product of claim 14, further comprising:
determining, based on the critical period data, GUI data that is operable to cause the display panel to visual depict a second simulation of the critical period, wherein the second simulation visually depicts the virtual roadway environment during the critical period, the dynamic object present in the monitored area during the critical period and how the virtual vehicle responded to the dynamic object during the critical period; and
providing the GUI data to the display panel so that the second simulation is visually depicted on the display panel.

18. The computer program product of claim 17, further comprising receiving an input describing a modification for a software model for the virtual control system based on how the virtual vehicle responded to the dynamic object during the critical period as visually depicted on the display panel during the second simulation, wherein the software model includes data that controls how the virtual vehicle responded to the dynamic object during the critical period.

19. The computer program product of claim 18, wherein the computer-executable code is operable so that the critical period data stored in the non-transitory memory is limited to only describing the critical period so that storage space in the non-transitory memory is preserved and the second simulation is limited so that only the critical period is depicted in the second simulation to thereby reduce review time of the second simulation and increase an accuracy of the modification relative to not limiting the critical period data.

20. The computer program product of claim 14, wherein the critical period data comes from the simulation and does not come from an image captured in a real-world.
